(19) United States
(12) Patent Application Publication
(10) Pub. No.: US 2019/0058742 A1
(43) Pub. Date: Feb. 21, 2019

(54) AUTOMATIC SURFACING OF PROMPTS FOR SHARING CONTENT IN MEETINGS

(71) Applicant: Microsoft Technology Licensing, LLC, Redmond, WA (US)

(72) Inventors: Eric Sexauer, Woodinville, WA (US); Ruchir Astavans, Redmond, WA (US)

(21) Appl. No.: 15/679,364

(22) Filed: Aug. 17, 2017

(51) Int. Cl. H04L 29/06; G06F 3/0482

(52) U.S. Cl. CPC H04L 65/403; G06F 3/0482

(57) ABSTRACT

Non-limiting examples of the present disclosure describe detection of a meeting status of a user and surfacing a prompt for sharing content for a meeting based on the detected meeting status. An exemplary application/service is configured to detect a meeting status of a user. The application/surface is further configured to detect creation of content on a computing device of a user. The meeting status is corresponded with the creation of the content. A prompt for sharing the created content is generated based on a correspondence of the meeting status with the creation of the content. For example, the prompt may be a prompt to share content with one or more users of a meeting. The prompt may be surfaced on a computing device of the user. In one example, the prompt may provide a listing of meetings for the user to select where to share the created content.

### BACKGROUND

Currently, applications for conducting a meeting are unaware when content is generated by a computing device of a user. If a user wishes to add content to a meeting, the user is required to manually locate meeting information and take further manual action to link the content to the meeting. In another instance, a user may be required to access a meeting invite to identify participants of the meeting and then take further manual action to share content with those meeting participants. Other common instances include those where a meeting is conducted ad-hoc. In that case, a meeting application may be playing catch up with respect to corresponding content with the ad-hoc meeting.

As such, examples described in the present disclosure are directed to improving processing efficiency and user interaction with a computing device and applications/services executing on the computing device, among other examples.

### SUMMARY

Non-limiting examples of the present disclosure describe detection of a meeting status of a user and surfacing a prompt for sharing content for a meeting based on the detected meeting status. An exemplary application/service is configured to detect a meeting status of a user. The application/surface is further configured to detect creation of content on a computing device of a user. The meeting status is corresponded with the creation of the content. A prompt for sharing the created content is generated based on a correspondence of the meeting status with the creation of the content. For example, the prompt may be a prompt to share content with one or more users of a meeting. The prompt may be surfaced on a computing device of the user. In one example, the prompt may provide a listing of meetings for the user to select where to share the created content. Other related examples are also described including selection of a modality for sharing based on a detected meeting status of a user, for example, where a life cycle of a meeting may be evaluated to determine how to surface a prompt for sharing content for a meeting.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an exemplary method related to surfacing of prompts for automatically sharing content for a meeting with which aspects of the present disclosure may be practiced.

FIG. 2 illustrates an exemplary method related to selection of a modality to aid automatic sharing of content for a meeting with which aspects of the present disclosure may be practiced.

FIG. 3 is a block diagram illustrating an example of a computing device with which aspects of the present disclosure may be practiced.

FIGS. 4A and 4B are simplified block diagrams of a mobile computing device with which aspects of the present disclosure may be practiced.

FIG. 5 is a simplified block diagram of a distributed computing system in which aspects of the present disclosure may be practiced.

### DETAILED DESCRIPTION

Examples described herein provide processing operations that are configured to enable an application/service to recognize a status of a user with respect to a meeting and make sharing of content available automatically to link content to a specific meeting. For instance, an exemplary application/service is configured to detect a meeting status of a user as well as detect creation of (or access to) content on a computing device of a user, for example, during a timing that corresponds with a meeting. The application/service is configured to automatically surface a prompt for sharing the content with users of a meeting based on processing operations described herein. An exemplary application/service is configured for team-based user collaboration (e.g. Teamspace™, OneNote®, Yammer®, etc.) but examples herein may also extend to any other application/service that is configured for content management including but not limited to: productivity applications/services (e.g. that of Office, Office365®), email applications/services, calendaring applications/services, meeting management applications/services, file-hosting applications/services (e.g. OneDrive®), social networking services and messaging applications/services (e.g. Skype®), among other examples.

A meeting status for a user may be determined that pertains to any of: a previously scheduled meeting, previously conducted meeting, a currently active meeting and a scheduled meeting (e.g. future meeting). Processing operations described herein include corresponding a meeting status with creation of (or access to) content on a computing device of a user. For example, an exemplary application/service is configured to correlate a timing of creation of or access to content (e.g. a timestamp associated with the content) with that of that of previously scheduled meetings, currently active meetings and/or upcoming scheduled meetings. Detection of a meeting status may further comprise evaluating a lifecycle of a meeting, which may correspond to a state of the meeting (e.g. finished, active, a state of an active meeting and how soon a scheduled meeting is to occur). In instances where a meeting status identifies that a user is currently attending a meeting, a determination of a meeting status may comprise evaluating a life cycle of the meeting to determine a specific point at which the meeting is currently at. For example, an exemplary application/service, in determining a meeting status, may identify that a meeting is scheduled for 30 minutes and the meeting is currently 20 minutes into that scheduled meeting time. This may assist the application/service in determining one or more of: a timing for surfacing an exemplary prompt and a modality by which to surface the prompt.

An exemplary prompt may be surfaced through a user interface of an exemplary application/service. A prompt may be generated using any of a plurality of modalities including but not limited to: notification, instant message, email message, in-application posting, etc. In one instance, surfacing of an exemplary prompt may comprise identification of specific content and a specific meeting (e.g. a meeting that a user is currently attending). An exemplary prompt may be a starting point for automatic sharing of content with one or more users of the meeting. For instance, a user interface may be configured to enable the user to make a single selection to automatically initiate sharing of content with users of a meeting. In some examples, an exemplary prompt may be configured to enable selection of specific users with whom to share specific content. In other examples, an exemplary prompt may comprise a listing of available meetings with which to automatically share content. For instance, a user interface of an exemplary application/service may detect a number of recently conducted, active or scheduled meetings, and provide a listing of the meetings for the user to disambiguate how to share content.

Accordingly, the present disclosure provides a plurality of technical advantages including but not limited to: improving processing efficiency (e.g., saving computing cycles/computing resources) for computing devices for correlation of created/accessed content to meetings, generation of customized prompts for automatic sharing of content with users of meetings, automatic surfacing of exemplary prompts to initiate sharing of content, improving user interaction with exemplary applications/services including real-time evaluation and management relating to meeting statuses of a user and extensibility to integrate processing operations described herein in a variety of different applications/services, among other examples.

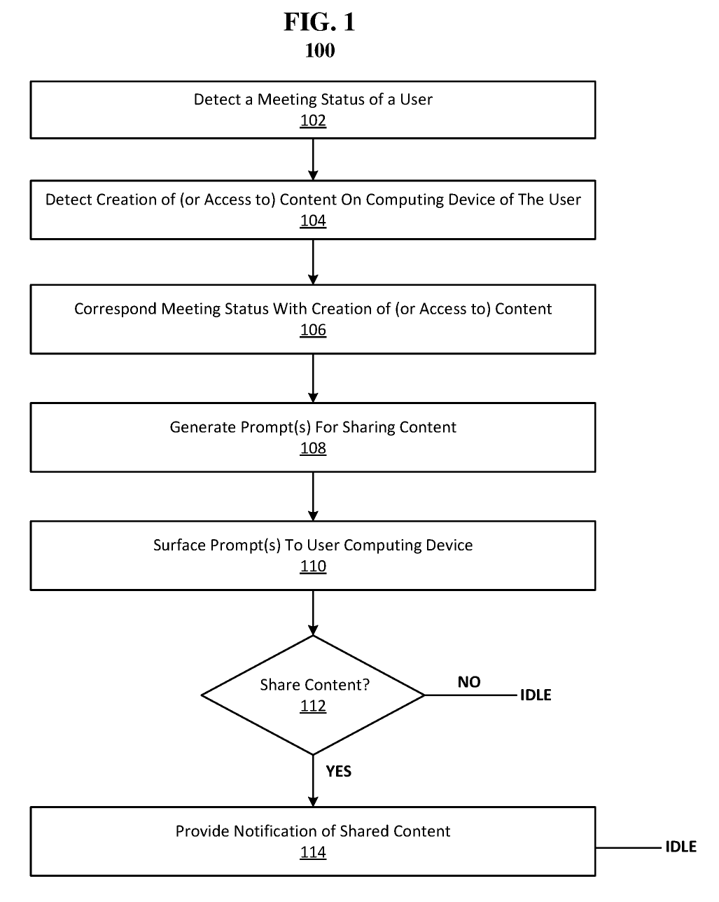

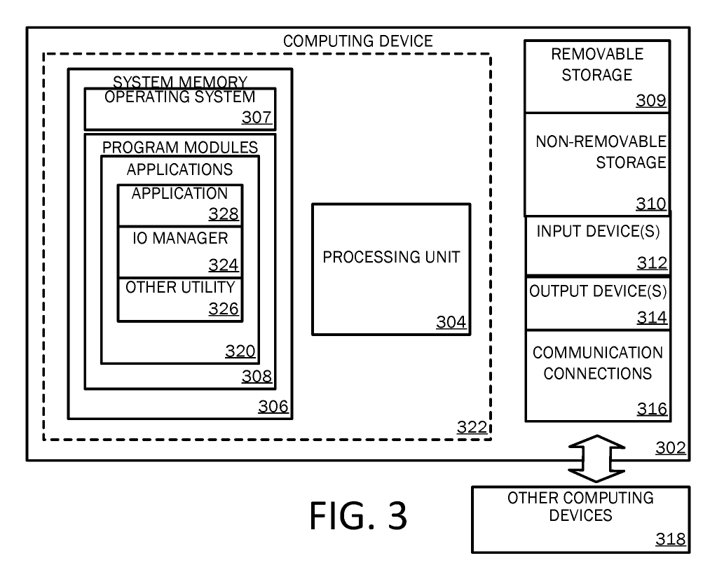

FIG. 1 illustrates an exemplary method 100 related to surfacing of prompts for automatically sharing content for a meeting with which aspects of the present disclosure may be practiced. As an example, method 100 may be executed by an exemplary processing device and/or system such as those shown in FIGS. 3-5. In examples, method 100 may execute on a device comprising at least one processor configured to store and execute operations, programs or instructions. Operations performed in method 100 may correspond to operations executed by a system and/or service that execute computer programs, application programming interfaces (APIs), neural networks or machine-learning processing, among other examples. As an example, processing operations executed in method 100 may be performed by one or more hardware components. In another example, processing operations executed in method 100 may be performed by one or more software components. In some examples, processing operations described in method 100 may be executed by one or more applications/services associated with a web service that has access to a plurality of application/services, devices, knowledge resources, etc. Processing operations described in method 100 may be implemented by one or more components connected over a distributed network.

Method 100 begins at processing operation 102, where a meeting status of a user is detected. An exemplary meeting status may be detected by an application/service that corresponds with a user account of a user. For instance, a user may sign in to an exemplary application/service that executes processing operations to detect a meeting status of a user. Examples of applications/services are provided in the foregoing description. In one example, an exemplary application/service is configured for team-based user collaboration (e.g. Teamspace™, OneNote®, Yammer®, etc.). However, as referenced above, examples herein may extend to any application/service that is configured for content management.

A meeting status for a user may be determined that pertains to any of: a previously scheduled meeting, previously conducted meeting, a currently active meeting and a scheduled meeting (e.g. future meeting). For instance, a meeting status may be an indication that a user is currently in a meeting, has previously conducted/attended/missed a meeting or has an upcoming scheduled meeting. A meeting may be an online meeting that is executed through an application/service. In other examples, reference to a meeting pertains to an in-person meeting or phone/teleconference meeting. In one instance, a meeting status of a user may be detected (processing operation 102) based on evaluation of a data of a user from within the application/service. For example, the application/service may be configured to obtain signal data when a user enters a scheduled meeting or initiates an ad-hoc meeting via the application/service. Further processing operations may comprise processing operations to analyze obtained signal data and make a determination as to the meeting status of the user.

In other instances, an exemplary application/service may execute processing operations that interface with other applications/services, for example, to detect (processing operation 102) a meeting status of a user that is associated with a user account of the application/service. Users may utilize other applications/services to conduct meetings and/or schedule meetings, where an exemplary application/service may be configured to obtain signal data from other applications/services to identify whether a user had a previous meeting scheduled, whether a meeting is currently being conducted and whether a user has upcoming meetings scheduled, etc. Examples of other applications/services include but are not limited to: calendaring applications/services, email applications/services, meeting applications/services, IP telephony applications/services messaging applications/services and social networking applications/services, among other examples. In one example, an exemplary application/service may obtain signal data from a calendaring application that comprises a schedule of online meetings for a user. For instance, the application/service may be configured to receive signal data when a user is currently attending a meeting. Processing operation 102 may further comprise operations to collect, parse and analyze such data, for example, to determine the meeting status of the user. Detection of a meeting status is not so limited where data indicating previously scheduled meetings, previously conducted meetings (e.g. unscheduled, ad-hoc) and future scheduled meetings may also be collected and evaluated. An exemplary application/service may be configured to periodically send out requests for a meeting status of a user, for example, to identify when a user is attending a meeting (scheduled or ad-hoc). Sending of requests for meeting status and/or responses to correspond with other applications/services may occur through an API or similar protocol. For example, an exemplary application/service is configured to receive signal data from another application/service when a user enters a meeting. In examples where previously scheduled meetings, previously conducted meetings or future scheduled meetings are identified, such meeting status data may be useful in corresponding detection of creation/access to content with a meeting time.

Detection of a meeting status may further comprise evaluating a lifecycle of a meeting, which may correspond to a state of the meeting. For example, a lifecycle of a meeting may be configured as an indication of a status of a meeting such as: finished, active, a state of an active meeting (e.g. close to ending) and how soon a scheduled meeting is to occur, among other examples. In instances where a meeting status identifies that a user is currently attending a meeting, a determination of a meeting status may comprise evaluating a life cycle of the meeting to determine a specific point at which the meeting is currently at. For example, an exemplary application/service, in determining a meeting status, may identify that a meeting is scheduled for 30 minutes and the meeting is currently 20 minutes into that scheduled meeting time. This may assist the application/service in determining one or more of: a timing for surfacing an exemplary prompt and a modality by which to surface the prompt.

Flow of method 100 proceeds to processing operation 104, where a detection occurs of either: creation of or access to content on a computing device of a user, for example, for correspondence with a detected meeting status. For example, an exemplary application/service may be configured to obtain signal data indicating creation of (or access to) content at a time that corresponds with a meeting. In doing so, the application/service is configured to interface with a computing device of a user and/or applications/services for content creation/management that are executing on an exemplary computing device of a user. Sending of requests for detection of creation/access to content and/or responses to correspond with computing devices and/or applications/services may occur through an API or similar protocol. Further processing operations executed in processing operation 104 may comprise operations that analyze content, metadata of content, etc. to identify additional data that may be useful for presentation in an exemplary prompt (e.g. that is generated and surfaced through methods disclosed herein).

In one example, the application/service is configured to obtain a signal (from a computing device or application/service) for detecting (processing operation 104) that a user has created content in association with receipt of a signal that indicates the user is currently attending a meeting (e.g. based on the meeting status). In one example, the created content is image content that is captured by the computing device. For instance, a user may take a picture of a whiteboard using its computing device while a meeting is occurring. The application/service may be configured to detect (processing operation 104) the creation of content for subsequent correspondence with a detected meeting status. While some examples described herein reference creation of content other examples of processing operation 104 may pertain to access to content. For instance, a user may be attending a business meeting and access a spreadsheet document with accounting data that the user may wish to share with other users involved in the meeting. The application/service may be configured to detect (processing operation 104) access to specific content and subsequently correspond the access with a detected meeting status. Content is not limited to image content, where processing operations described herein can be configured to work with any type of content including but not limited to: image content, video content, audio content and document content, among other examples).

At processing operation 106, an exemplary application/service is configured to correspond the detected meeting status with the detection of creation of (or access to) specific content. For example, an exemplary application/service, in processing operation 106, is configured to correlate a timing of creation of or access to content (e.g. a timestamp associated with the content) with that of that of previously scheduled meetings, currently active meetings and/or upcoming scheduled meetings, etc. Correspondence (processing operation 106) of a detected meeting status with specific content may occur based on a matching of detection results (from processing operations 102 and 104, respectively) with time data for a meeting (e.g. previously scheduled/conducted, active or scheduled meeting). Correspondence between a meeting status and content may further factor in the determined lifecycle for the meeting.

In one example, processing operation 106 may comprise corresponding a signal indicating that a user is in a meeting and a signal indicating content is created/accessed during the time the user is in the meeting. In some examples, a threshold determination may be applied to correspond specific content with a specific meeting. Developers may set time periods for corresponding created/accessed content with a specific meeting. Thresholds for corresponding content to meetings may vary without departing from the spirit of the present disclosure. For instance, a previously conducted meeting may have occurred from 12:30 pm-1:00 pm and content may have been created at 1:04 pm, which may fall within the threshold for associating the specific content with a specific meeting.

Further examples of processing operation 106 may comprise evaluating specific attributes of the content (e.g. recognition processing and/or metadata) and matching the specific attributes with the determined life cycle of the meeting and/or data associated with a meeting invite for a meeting or users involved in the meeting. For instance, a user may have accessed a spreadsheet document with accounting data and the subject line for a meeting invite may be something like “accounting review”. In another example, recognition processing (e.g. OCR) for image content may be executed to identify that image content is a whiteboard image and further metadata associated with that image content (e.g. timestamp and geo-locational data) may be analyzed to identify that the image content was taken in a location of a scheduled meeting. In yet another example, specific content may be identified as audio file and a message posting may be identified, from a user account of another user involved in the meeting, that asks a user for that specific audio file. Evaluating data/metadata associated with content in association with specific data retrieved from a meeting invite (or user account associated with a meeting invite) may assist with accuracy in correlating created/accessed content with a specific meeting.

Flow of method 100 may proceed to processing operation 108, where an exemplary prompt (or prompts) is generated for sharing of the created/accessed content. Processing operation 108 comprises generating a prompt for a sharing of the created (or accessed) content with one or more other users of a meeting based on a correspondence (processing operation 106) of the meeting status with the created/accessed content. An exemplary prompt is a UI notification to a user that can enable automatic sharing of created/accessed content with one or more users of a specific meeting. A prompt may comprise a single message or multiple layers of messaging that may include selectable UI features for customizing the sharing of content. Generation (processing operation 108) of an exemplary prompt may comprise specifically tailoring the prompt based on the detected content and the detected meeting status of the user. In instances where a prompt correlates specific content to a specific meeting, surfacing (processing operation 110) of the prompt may further factor in a determined lifecycle of a meeting, for example, to determine a timing of when to surface the prompt and/or a specific modality to surface the prompt.

Content include in a prompt may vary based on the results of processing operation 106 as described in the foregoing. For example, a prompt may comprise identification of specific content and a specific meeting that the content may correspond with. In other examples, an exemplary prompt may comprise a listing of meetings that are associated with the user. An exemplary listing of meetings may comprise one or more selected from a group consisting of: previously scheduled meetings, previously conducted meetings, currently active meetings and scheduled meetings. For example, results from correspondence processing (processing operation 106) may not concretely link specific content to a specific meeting. Thus, instead of making a false assumption for sharing of content, an exemplary prompt may be generated (processing operation 108) to initiate sharing of content by the user where the user can make specific selections of content for sharing with users of specific meetings. In other examples, prompts may be generated (processing operation 108) based on user settings (e.g. set in a user profile) associated with an exemplary application/service.

Flow may proceed to processing operation 110, where a generated prompt is surfaced to a computing device of a user. Processing operation 110 may automatically surface a generated prompt to initiate sharing of the created/accessed content with other users of a meeting. An exemplary prompt may be surfaced automatically upon generation or the prompt may be automatically surfaced at a specific time that is determined based on evaluation of the lifecycle of a meeting. An exemplary prompt may be a starting point for automatic sharing of content with one or more users of the meeting. For instance, a user interface may be configured to enable the user to make a single selection to automatically initiate sharing of content with users of a meeting. In some examples, an exemplary prompt may be configured to enable selection of specific users with whom to share specific content. In other examples, an exemplary prompt may comprise a listing of available meetings with which to automatically share content. For instance, a user interface of an exemplary application/service may detect a number of recently conducted, active or scheduled meetings and provide a listing of the meetings for the user to disambiguate how to share content.

In one example, an exemplary prompt is surfaced (processing operation 110) that correlates specific content to a specific meeting. In another example, surfacing (processing operation 110) comprises providing a representation of created/accessed content and a listing of meetings for the user to select a specific meeting for sharing of the content. In examples where the prompt is generated for sharing of content in an active meeting, the surfacing (processing operation 110) automatically surfaces the prompt on the computing device at a timing that is concurrent with execution of the meeting. A prompt may be surface through any of a plurality of modalities including but not limited to: notification, instant message, email message, in-application posting, etc. In instances where a prompt correlates specific content to a specific meeting, surfacing (processing operation 110) of the prompt may further factor in a determined lifecycle of a meeting, for example, to determine a timing of when to surface the prompt and/or a specific modality to surface the prompt.

Further data that may be included in a surfaced prompt includes the ability for users to select, through the user interface of the application/service, specific content to share. In some instances, correspondence processing (processing operation 106) of the content to a specific meeting may auto-suggest content to be shared. However, an exemplary prompt may be configured to enable the user to modify content selection for sharing. In other instances, an exemplary prompt may comprise user interface features for selecting users to share the content with as well as setting privileges for sharing content. Moreover, an exemplary prompt may further take advantage of interfacing with other applications/services, where an exemplary prompt may further comprise triggers to connect uses with other related content (e.g. meeting notes, user accounts, related tenants/channels, search results, social networking posts, etc.).

In alternative examples of processing operation 110, an exemplary prompt may be sent to and surfaced on a plurality of computing devices of a user. For instance, a user may be using multiple computing devices during conducting of a meeting (e.g. multimodal communications). In one instance, multiple versions of the prompt are surface (on different computing devices) where a selection pertaining to the prompt (that is made through one of the computing devices) may be synchronized across computing devices of the user.

Flow may proceed to decision operation 112, where it is determined whether a selection is received (through the prompt/prompts) to share content with users of a meeting. For instance, a user may utilize an exemplary prompt to initiate automatic sharing of content with one or more users of a meeting. If no sharing is to occur, flow of decision operation 112 branches NO and processing of method 100 remains idle until subsequent processing occurs. If a selection through a UI of the application/service is received that indicates sharing of content, flow of decision operation 112 branches YES and processing of method 100 proceeds to processing operation 114. At processing operation 114, a notification is provided that indicates content is shared with one or more users of a meeting. Processing operation 114 may comprise providing the notification to a computing device of a user, for example, through the exemplary application/service. Processing operation 114 may further comprise providing notifications of sharing of content with to other user accounts of the application/service.

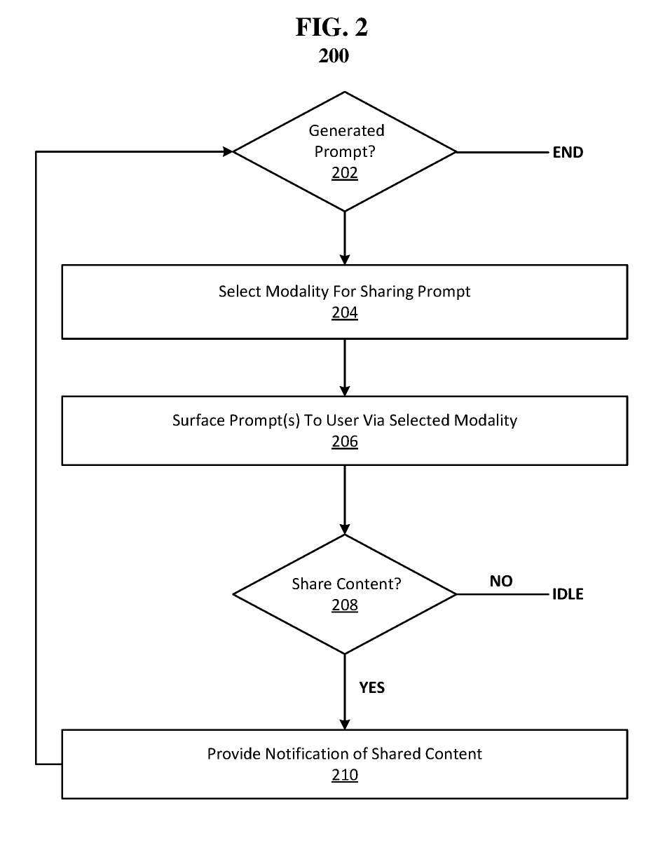

FIG. 2 illustrates an exemplary method 200 related to selection of a modality to aid automatic sharing of content for a meeting with which aspects of the present disclosure may be practiced. As an example, method 200 may be executed by an exemplary processing device and/or system such as those shown in FIGS. 3-5. In examples, method 200 may execute on a device comprising at least one processor configured to store and execute operations, programs or instructions. Operations performed in method 200 may correspond to operations executed by a system and/or service that execute computer programs, application programming interfaces (APIs), neural networks or machine-learning processing, among other examples. As an example, processing operations executed in method 200 may be performed by one or more hardware components. In another example, processing operations executed in method 200 may be performed by one or more software components. In some examples, processing operations described in method 200 may be executed by one or more applications/services associated with a web service that has access to a plurality of application/services, devices, knowledge resources, etc. Processing operations described in method 200 may be implemented by one or more components connected over a distributed network.

Method 200 begins at decision operation 202, where it is determined whether a prompt is generated for sharing of content with users of a meeting. Processing operations related to generation of an exemplary prompt have been described in the foregoing description of method 100 (e.g. processing operation 108). In examples where a prompt is not generated for sharing of content, flow of decision operation 202 branches NO and processing of method 200 ends. In examples where an exemplary prompt is generated, flow of decision operation 202 branches YES and processing of method 200 proceeds to processing operation 204.

At processing operation 204, a modality is selected for sharing of the generated prompt. A selected modality is used to surface the generated prompt. Processing operations related to selection of an exemplary modality may be executed before an exemplary prompt is surfaced. In one example, an exemplary application/service is configured to enable multimodal communications for a meeting where a user may communicate through multiple modalities (e.g. instant messaging, a messaging application executing an electronic meeting, email, etc.) to carry on a meeting. In other examples, an exemplary application/service may interface with other applications/surfaces to generate and surface an exemplary prompt. For instance, a meeting may be conducted using a first application/service and a modality in which the prompt is surfaced may be in second application/service. In one example, a platform (e.g. Microsoft® Google®) may provide access to a plurality of different application/services that can be utilized to surface an exemplary prompt.

Selection (processing operation 204) of a modality to surface a generated prompt may comprise detection of an exemplary meeting status of the user and/or evaluating results from correspondence processing (processing operation 106) described in method 100. For example, a modality may be selected based on any of: the type of content that is created/accessed, the detected meeting status as well as other signal data collected from a computing device of a user. In some examples, surfacing of an exemplary prompt may overlay other content within a user interface of an exemplary application/service. In other examples, placement of the prompt may vary within a user interface of an application/service or be surfaced through another application/service. In one example, a user may be conducting a meeting using the application/service where it is determined that the user is utilizing multiple modalities (instant messaging, voice call/messaging application/service, etc.) to carry out the meeting. In such an instance, this data may be useful to help surface the prompt in a manner that is most suitable for the user. If the user is continuously using the instant messaging modality, the prompt may be surfaced in the instant messaging portion of the user interface of the application/service.

Furthermore, selection (processing operation 204) of a modality may further comprise determining a timing for surfacing a prompt via a selected modality. As described in the foregoing, a lifecycle of a meeting may be evaluated to aid selection of a modality and a determination of timing for surfacing a prompt. In another example, detection of a meeting status and correspondence with the created/accessed content may evaluate a life cycle of a meeting and determine that a meeting (in an application/service) is ending very shortly and the content may be best shared at a later point in time using a different modality. Continuing that example, a determination may be made to surface the prompt at a later point in time and using a different modality such as by sending up a follow-up email, posting a message on a tenant/channel of a collaborative application/service, etc.

At processing operation 206, the generated prompt is surfaced to the user via the selected modality. An exemplary prompt may be surfaced automatically upon generation or the prompt may be automatically surfaced at a specific time that is determined based on evaluation of the lifecycle of a meeting. Processing operations related to surfacing of an exemplary prompt have been described in the foregoing description of method 100 (e.g. processing operation 110).

Flow may proceed to decision operation 208, where it is determined whether a selection is received (through the prompt/prompts) to share content with users of a meeting. For instance, a user may utilize an exemplary prompt to initiate automatic sharing of content with one or more users of a meeting. If no sharing is to occur, flow of decision operation 208 branches NO and processing of method 200 remains idle until subsequent processing occurs. If a selection through a UI of the application/service is received that indicates sharing of content, flow of decision operation 208 branches YES and processing of method 200 proceeds to processing operation 210. At processing operation 210, a notification is provided that indicates content is shared with one or more users of a meeting. Processing operation 210 may comprise providing the notification to a computing device of a user, for example, through the selected modality (or an alternative modality). Processing operation 210 may further comprise providing notifications of sharing of content with to other user accounts of the application/service through the selected modality (or an alternative modality).

FIGS. 3-5 and the associated descriptions provide a discussion of a variety of operating environments in which examples of the invention may be practiced. However, the devices and systems illustrated and discussed with respect to FIGS. 3-5 are for purposes of example and illustration and are not limiting of a vast number of computing device configurations that may be utilized for practicing examples of the invention, described herein. FIG. 3 is a block diagram illustrating physical components of a computing device 302, for example a mobile processing device, with which examples of the present disclosure may be practiced. Among other examples, computing device 302 may be an exemplary computing device configured for surfacing of prompts for automatic sharing of content for a meeting as described herein. In a basic configuration, the computing device 302 may include at least one processing unit 304 and a system memory 306. Depending on the configuration and type of computing device, the system memory 306 may comprise, but is not limited to, volatile storage (e.g., random access memory), non-volatile storage (e.g., read-only memory), flash memory, or any combination of such memories. The system memory 306 may include an operating system 307 and one or more program modules 308 suitable for running software programs/modules 320 such as IO manager 324, other utility 326 and application 328. As examples, system memory 306 may store instructions for execution. Other examples of system memory 306 may store data associated with applications. The operating system 307, for example, may be suitable for controlling the operation of the computing device 302. Furthermore, examples of the invention may be practiced in conjunction with a graphics library, other operating systems, or any other application program and is not limited to any particular application or system. This basic configuration is illustrated in FIG. 3 by those components within a dashed line 322. The computing device 302 may have additional features or functionality. For example, the computing device 302 may also include additional data storage devices (removable and/or non-removable) such as, for example, magnetic disks, optical disks, or tape. Such additional storage is illustrated in FIG. 3 by a removable storage device 309 and a non-removable storage device 310.

As stated above, a number of program modules and data files may be stored in the system memory 306. While executing on the processing unit 304, program modules 308 (e.g., Input/Output (I/O) manager 324, other utility 326 and application 328) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 3 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 402 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 302 may also have one or more input device(s) 312 such as a keyboard, a mouse, a pen, a sound input device, a device for voice input/recognition, a touch input device, etc. The output device(s) 314 such as a display, speakers, a printer, etc. may also be included. The aforementioned devices are examples and others may be used. The computing device 302 may include one or more communication connections 316 allowing communications with other computing devices 318. Examples of suitable communication connections 316 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 306, the removable storage device 309, and the non-removable storage device 310 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 302. Any such computer storage media may be part of the computing device 302. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

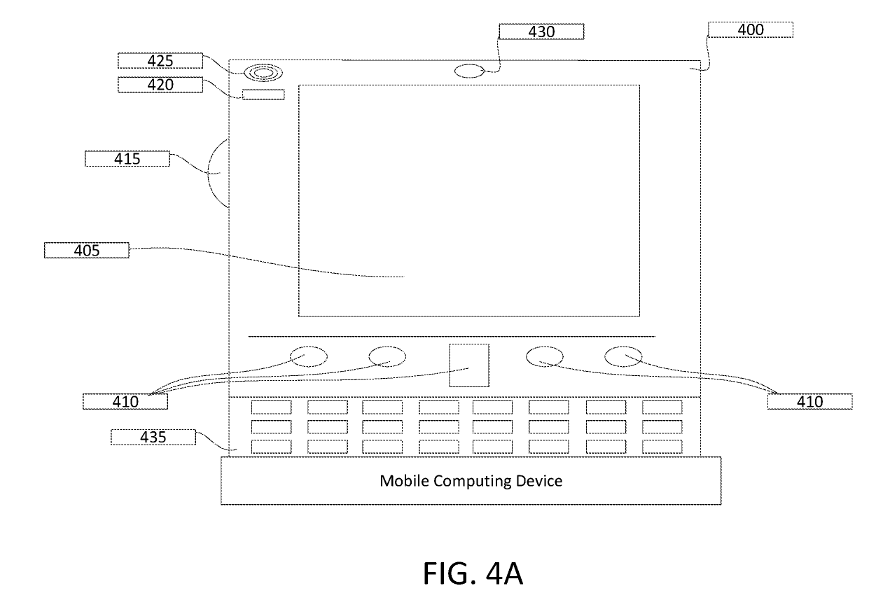

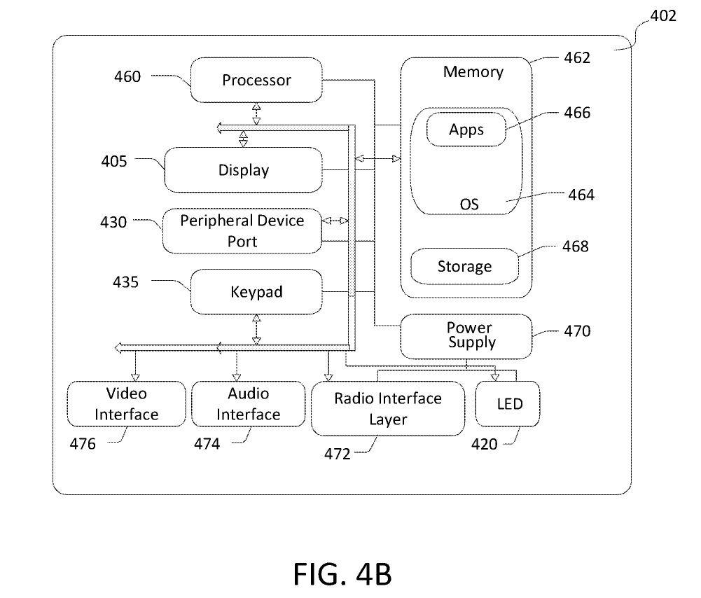

FIGS. 4A and 4B illustrate a mobile computing device 400, for example, a mobile telephone, a smart phone, a personal data assistant, a tablet personal computer, a phablet, a slate, a laptop computer, and the like, with which examples of the invention may be practiced. Mobile computing device 400 may be an exemplary computing device configured for surfacing of prompts for automatic sharing of content for a meeting as described herein. Application command control may be provided for applications executing on a computing device such as mobile computing device 400. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 4A, one example of a mobile computing device 400 for implementing the examples is illustrated. In a basic configuration, the mobile computing device 400 is a handheld computer having both input elements and output elements. The mobile computing device 400 typically includes a display 405 and one or more input buttons 410 that allow the user to enter information into the mobile computing device 400. The display 405 of the mobile computing device 400 may also function as an input device (e.g., touch screen display). If included, an optional side input element 415 allows further user input. The side input element 415 may be a rotary switch, a button, or any other type of manual input element. In alternative examples, mobile computing device 400 may incorporate more or less input elements. For example, the display 405 may not be a touch screen in some examples. In yet another alternative example, the mobile computing device 400 is a portable phone system, such as a cellular phone. The mobile computing device 400 may also include an optional keypad 435. Optional keypad 435 may be a physical keypad or a “soft” keypad generated on the touch screen display or any other soft input panel (SIP). In various examples, the output elements include the display 405 for showing a GUI, a visual indicator 420 (e.g., a light emitting diode), and/or an audio transducer 425 (e.g., a speaker). In some examples, the mobile computing device 400 incorporates a vibration transducer for providing the user with tactile feedback. In yet another example, the mobile computing device 400 incorporates input and/or output ports, such as an audio input (e.g., a microphone jack), an audio output (e.g., a headphone jack), and a video output (e.g., a HDMI port) for sending signals to or receiving signals from an external device.

FIG. 4B is a block diagram illustrating the architecture of one example of a mobile computing device. That is, the mobile computing device 400 can incorporate a system (i.e., an architecture) 402 to implement some examples. In one examples, the system 402 is implemented as a “smart phone” capable of running one or more applications (e.g., browser, e-mail, calendaring, contact managers, messaging clients, games, and media clients/players). In some examples, the system 402 is integrated as a computing device, such as an integrated personal digital assistant (PDA), tablet and wireless phone.

One or more application programs 466 may be loaded into the memory 462 and run on or in association with the operating system 464. Examples of the application programs include phone dialer programs, e-mail programs, personal information management (PIM) programs, word processing programs, spreadsheet programs, Internet browser programs, messaging programs, and so forth. The system 402 also includes a non-volatile storage area 468 within the memory 462. The non-volatile storage area 468 may be used to store persistent information that should not be lost if the system 402 is powered down. The application programs 466 may use and store information in the non-volatile storage area 468, such as e-mail or other messages used by an e-mail application, and the like. A synchronization application (not shown) also resides on the system 402 and is programmed to interact with a corresponding synchronization application resident on a host computer to keep the information stored in the non-volatile storage area 468 synchronized with corresponding information stored at the host computer. As should be appreciated, other applications may be loaded into the memory 462 and run on the mobile computing device (e.g. system 402) described herein.

The system 402 has a power supply 470, which may be implemented as one or more batteries. The power supply 470 might further include an external power source, such as an AC adapter or a powered docking cradle that supplements or recharges the batteries.

The system 402 may include peripheral device port 430 that performs the function of facilitating connectivity between system 402 and one or more peripheral devices. Transmissions to and from the peripheral device port 430 are conducted under control of the operating system (OS) 464. In other words, communications received by the peripheral device port 430 may be disseminated to the application programs 466 via the operating system 464, and vice versa.

The system 402 may also include a radio interface layer 472 that performs the function of transmitting and receiving radio frequency communications. The radio interface layer 472 facilitates wireless connectivity between the system 402 and the “outside world,” via a communications carrier or service provider. Transmissions to and from the radio interface layer 472 are conducted under control of the operating system 464. In other words, communications received by the radio interface layer 472 may be disseminated to the application programs 566 via the operating system 464, and vice versa.

The visual indicator 420 may be used to provide visual notifications, and/or an audio interface 474 may be used for producing audible notifications via the audio transducer 425 (as described in the description of mobile computing device 400). In the illustrated example, the visual indicator 420 is a light emitting diode (LED) and the audio transducer 425 is a speaker. These devices may be directly coupled to the power supply 470 so that when activated, they remain on for a duration dictated by the notification mechanism even though the processor 460 and other components might shut down for conserving battery power. The LED may be programmed to remain on indefinitely until the user takes action to indicate the powered-on status of the device. The audio interface 474 is used to provide audible signals to and receive audible signals from the user. For example, in addition to being coupled to the audio transducer 425 (shown in FIG. 4A), the audio interface 474 may also be coupled to a microphone to receive audible input, such as to facilitate a telephone conversation. In accordance with examples of the present invention, the microphone may also serve as an audio sensor to facilitate control of notifications, as will be described below. The system 402 may further include a video interface 476 that enables an operation of an on-board camera 430 to record still images, video stream, and the like.

A mobile computing device 400 implementing the system 402 may have additional features or functionality. For example, the mobile computing device 400 may also include additional data storage devices (removable and/or non-removable) such as, magnetic disks, optical disks, or tape. Such additional storage is illustrated in FIG. 4B by the non-volatile storage area 468.

Data/information generated or captured by the mobile computing device 400 and stored via the system 402 may be stored locally on the mobile computing device 400, as described above, or the data may be stored on any number of storage media that may be accessed by the device via the radio 472 or via a wired connection between the mobile computing device 400 and a separate computing device associated with the mobile computing device 400, for example, a server computer in a distributed computing network, such as the Internet. As should be appreciated such data/information may be accessed via the mobile computing device 400 via the radio 472 or via a distributed computing network. Similarly, such data/information may be readily transferred between computing devices for storage and use according to well-known data/information transfer and storage means, including electronic mail and collaborative data/information sharing systems.

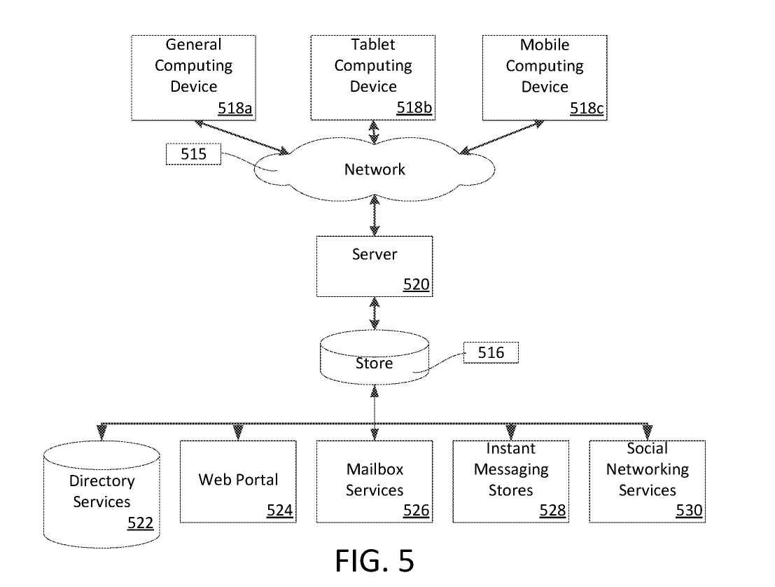

FIG. 5 illustrates one example of the architecture of a system for providing an application that reliably accesses target data on a storage system and handles communication failures to one or more client devices, as described above. The system of FIG. 5 may be an exemplary system configured for surfacing of prompts for automatic sharing of content for a meeting as described herein. Target data accessed, interacted with, or edited in association with programming modules 308 and/or applications 320 and storage/memory (described in FIG. 3) may be stored in different communication channels or other storage types. For example, various documents may be stored using a directory service 522, a web portal 524, a mailbox service 526, an instant messaging store 528, or a social networking site 530, IO manager 324, other utility 326, application 328 and storage systems may use any of these types of systems or the like for enabling data utilization, as described herein. A server 520 may provide storage system for use by a client operating on general computing device 302 and mobile device(s) 400 through network 515. By way of example, network 515 may comprise the Internet or any other type of local or wide area network, and a client node may be implemented for connecting to network 515. Examples of a client node comprise but are not limited to: a computing device 302 embodied in a personal computer, a tablet computing device, and/or by a mobile computing device 400 (e.g., mobile processing device). As an example, a client node may connect to the network 515 using a wireless network connection (e.g. WiFi connection, Bluetooth, etc.). However, examples described herein may also extend to connecting to network 515 via a hardwire connection. Any of these examples of the client computing device 302 or 400 may obtain content from the store 516.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
detecting a meeting status of a user;
detecting a creation of content on a computing device of a user;
corresponding the meeting status with the creation of content;
generating a prompt for a sharing of the created content with one or more other users of a meeting based on a correspondence of the meeting status with the creation of the content; and
surfacing the prompt on the computing device of the user.

2. The method of claim 1, wherein the created content is image content that is captured by the computing device.

3. The method of claim 1, wherein the detecting of the meeting status comprises detecting that the user is currently attending the meeting, and wherein the generating tailors the prompt specifically for sharing the created content with one or more other users of a meeting.

4. The method of claim 1, wherein the surfacing automatically surfaces the prompt on the computing device at a timing that is concurrent with execution of the meeting.

5. The method of claim 1, wherein the generating of the prompt further comprises compiling a listing of meetings that are associated with the user, and wherein the surfacing further comprises providing a representation of the created content and the listing of meetings for the user to select a specific meeting for sharing of the created content.

6. The method of claim 5, wherein the listing of meetings that are associated with the user comprises one or more selected from a group consisting of: previously scheduled meetings, previously conducted meetings, currently active meetings and scheduled meetings.

7. The method of claim 1, further comprising: receiving input to share the created content with the one or more other users of the meeting and sharing the created content with the one or more other users based on the received input to share the created content.

8. A system comprising:
at least one processor; and
a memory, operatively connected with the at least one processor, storing computer-executable instructions that, when executed by the at least one processor, causes the at least one processor to execute a method that comprises:
detecting a meeting status of a user;
detecting a creation of content on a computing device of a user;
corresponding the meeting status with the creation of content;
generating a prompt for a sharing of the created content with one or more other users of a meeting based on a correspondence of the meeting status with the creation of the content; and
surfacing the prompt on the computing device of the user.

9. The system of claim 8, wherein the created content is image content that is captured by the computing device.

10. The system of claim 8, wherein the detecting of the meeting status comprises detecting that the user is currently attending the meeting, and wherein the generating tailors the prompt specifically for sharing the created content with one or more other users of a meeting.

11. The system of claim 8, wherein the surfacing automatically surfaces the prompt on the computing device at a timing that is concurrent with execution of the meeting.

12. The system of claim 8, wherein the generating of the prompt further comprises compiling a listing of meetings that are associated with the user, and wherein the surfacing further comprises providing a representation of the created content and the listing of meetings for the user to select a specific meeting for sharing of the created content.

13. The system of claim 12, wherein the listing of meetings that are associated with the user comprises one or more selected from a group consisting of: previously scheduled meetings, previously conducted meetings, currently active meetings and scheduled meetings.

14. The system of claim 8, wherein the executed method further comprising: receiving input to share the created content with the one or more other users of the meeting and sharing the created content with the one or more other users based on the received input to share the created content.

15. A computer-readable medium storing computer-executable instructions that, when executed by at least one processor, causes the at least one processor to execute a method comprising:
detecting a meeting status of a user;
detecting a creation of content on a computing device of a user;
corresponding the meeting status with the creation of content;
generating a prompt for a sharing of the created content with one or more other users of a meeting based on a correspondence of the meeting status with the creation of the content; and
surfacing the prompt on the computing device of the user.

16. The computer-readable medium of claim 15, wherein the created content is image content that is captured by the computing device.

17. The computer-readable medium of claim 15, wherein the detecting of the meeting status comprises detecting that the user is currently attending the meeting, wherein the generating tailors the prompt specifically for sharing the created content with one or more other users of a meeting, and wherein the surfacing automatically surfaces the prompt on the computing device at a timing that is concurrent with execution of the meeting.

18. The computer-readable medium of claim 15, wherein the generating of the prompt further comprises compiling a listing of meetings that are associated with the user, and wherein the surfacing further comprises providing a representation of the created content and the listing of meetings for the user to select a specific meeting for sharing of the created content.

19. The computer-readable medium of claim 18, wherein the listing of meetings that are associated with the user comprises one or more selected from a group consisting of: previously scheduled meetings, previously conducted meetings, currently active meetings and scheduled meetings.

20. The computer-readable medium of claim 15, wherein the executed method further comprising: receiving input to share the created content with the one or more other users of the meeting and sharing the created content with the one or more other users based on the received input to share the created content.
